(19) United States
(12) Patent Application Publication
(10) Pub. No.: US 2018/0075443 A1
(43) Pub. Date: Mar. 15, 2018

(54) Mobile Payment for Goods and Services

(71) Applicants: Hans-Peter Fischer, Puchheim (DE); Olaf Loga, Muenchen (DE); Gerry Bartunek, Greenville, SC (US); Kyle Jernigan, Greenville, SC (US)

(72) Inventors: Hans-Peter Fischer, Puchheim (DE); Olaf Loga, Muenchen (DE); Gerry Bartunek, Greenville, SC (US); Kyle Jernigan, Greenville, SC (US)

(21) Appl. No.: 15/261,476

(22) Filed: Sep. 9, 2016

(51) Int. Cl. G06Q 20/32; G06Q 20/40

(52) U.S. Cl. CPC G06Q 20/3227; G06Q 20/40

(57) ABSTRACT

A method for a mobile payment transaction using a mobile communication device include reading a unique product ID by means of the mobile communication device by a user of the mobile communication device; retrieving product information relating to the unique product ID from a product billing server, and deciding whether the product ID is a purchase item product or a time-dependent article product. The method also include initiating a mobile payment operation by the user of the mobile communication device on the basis of the unique product ID, sending payment information from the mobile communication device to a payment server on the basis of the unique product ID, and forming a communications link from the payment server to a product billing server on the basis of the payment information. The method further includes receiving payment price information by the payment server, acknowledging the payment price on the product billing server on the basis of the payment price information, and confirming a conclusion of the mobile payment operation to the mobile communication device by means of at least one server involved in the mobile payment operation. In case where the product is a time-dependent article, the method also includes initiating a product registration operation for the user of the mobile communication device on the basis of the unique product ID, transmitting a registration enquiry from the mobile communication device to the product billing server on the basis of the unique product ID; registering the user of the mobile communication device for the time-dependent article on the product billing server, and confirming a registration of the user for the corresponding product through the product billing server to the mobile communication device.

### CROSS REFERENCE TO RELATED APPLICATIONS

This application is a continuation of PCT International Application No. PCT/EP2015/052118, filed Feb. 3, 2015, which claims priority under 35 U.S.C. § 119 from German Patent Application No. 10 2014 204 440.5, filed Mar. 11, 2014, the entire disclosures of which are herein expressly incorporated by reference.

### BACKGROUND AND SUMMARY OF THE INVENTION

The present invention relates to a method for a mobile payment transaction using a mobile communication device, and to a relevant device.

Customary mobile payment systems are restricted to payment transactions at so-called point-of-service (POS) terminals. This can be effected by means of, for example, a bar code, quick response (“QR”) code or radio frequency identification (“RFID”) at the POS terminal. In the case of a bar code or a QR code, the customer usually keeps the corresponding code for the product to be acquired on the display of his/her smartphone and holds the display against a POS terminal via a scanner of the POS terminal. In this process the code is scanned—that is to say, read out—and the payment transaction is initiated. In this process, either the customer keeps his/her personal information that is relevant to the payment on this smartphone or the customer stores this information on a back-end server of the enterprise at which he/she is a customer, or alternatively he/she has to make a card payment or a cash payment in the conventional way.

If the customer keeps his/her personal information that is relevant to the payment on a back-end server of the corresponding enterprise, the corresponding code displayed on the display of the smartphone contains information to identify the customer, or at least some of this personal information that is relevant to the payment, in order to be able to implement the payment transaction.

A further variant of payment by means of a bar code or a QR code is that the customer reads out this code by means of a camera of his/her smartphone and then undertakes the payment transaction on his/her smartphone by means of the information, contained in the code, about the product to be acquired, such as purchase price and product ID, by entering his/her payment PIN at the enterprise itself or at an external enterprise—such as, for example, the payment service provider PayPal™—which settles the payment.

It would therefore be desirable to provide an option that simplifies the payment for arbitrary products still further for the customer.

An objective of the invention is to propose an even simpler payment option for the customer, which avoids or at least reduces at least some of the disadvantages known in the state of the art.

The subject-matter of the disclosure relates to a method for a mobile payment transaction using a mobile communication device, said method comprising: reading-in of a unique product ID, by a user of the mobile communication device, using the mobile communication device; retrieving an item of product information relating to the unique product ID from a product-supplier server; deciding whether the product ID concerns a product of an article for purchase or a product of a time-dependent article; initiating of a mobile payment transaction by the user of the mobile communication device on the basis of the unique product ID; sending an item of payment information from the mobile communication device to a payment server on the basis of the unique product ID; establishing a communications link from the payment server to the product-supplier server on the basis of the item of payment information; receiving of an item of payment-price information by the payment server; acknowledging a payment price to the product-supplier server on the basis of the item of payment-price information; and confirming of a completion of the mobile payment transaction to the mobile communication device by at least one server involved in the mobile payment transaction. And, in the case where the product is a time-dependent article, initiating a product log-in procedure for the user of the mobile communication device on the basis of the unique product ID; sending a log-in request from the mobile communication device to the product-supplier server on the basis of the unique product ID; logging-in of the user of the mobile communication device for the time-dependent article at the product-supplier server; and confirming, by the product-supplier server to the mobile communication device, of a logging-in of the user for the corresponding product.

A ‘mobile payment transaction’ in the sense of the invention may mean a payment transaction that is capable of being implemented using a mobile terminal appliance such as, for example, a mobile communication device of the user—that is to say, of the customer. Preferentially, a payment transaction may be meant that can be undertaken by the customer in mobile manner—that is to say, without being dependent on a POS terminal for the payment transaction.

A ‘mobile communication device’ in the sense of the invention means a communication device that is suitable to be carried by the customer in mobile manner in the hand and/or on the body, and to implement at least parts of a payment transaction for a product to be acquired by the customer. Preferentially, a pad, a smartphone, a smartwatch, smartglasses and such like may be meant by the ‘mobile communication device’.

A ‘unique product ID’ in the sense of the invention may be an item of information that uniquely defines—that is to say, identifies—a product and/or a set of identical products.

An ‘item of product information’ in the sense of the invention may be an item of information that contains further information about the product and/or the set of identical products. In particular, an item of information may be contained, from which it is evident which type of product is concerned, in particular whether it is a question of a product of an article for purchase or a product of a time-dependent article.

A ‘product-supplier server’ in the sense of the invention may be a server or even a server system in which, in particular, further information is held relating to a product ID—that is to say, in particular, product information. Furthermore, payment information may also be kept that is necessary for the payment settlement on the part of the product supplier. A product-supplier server may also be a distributed server system such as, for example, a cloud, a server array or such like.

An ‘article for purchase’ in the sense of the invention may be any permanently acquirable product and also a product that is permanently acquirable but, by reason of its nature, is only capable of being utilized in accordance with its intended purpose for a limited time—such as, for example, a consumable commodity. The permanently acquirable product may be both of a physical nature and of an electronic nature.

In contrast to this, a ‘time-dependent article’ in the sense of the invention may be an acquirable product which by its nature is capable of being utilized only during a certain period of time—such as, for example, a rental product or a season ticket. Such a product may be both of a physical nature and of an electronic nature.

An ‘item of payment information’ in the sense of the invention may be any item of information that is necessary for the payment for and/or the payment settlement of the acquisition of the product. In particular, an item of payment information may contain person-specific information concerning who is the purchaser of the product and the account from which the purchase price is to be demanded or, as the case may be, debited or transferred. An item of payment information may also include an item of information about the payment mechanism that is to be applied and/or the payment handler that is to be integrated into the mobile payment transaction.

A ‘payment server’ in the sense of the invention may be a server or a server system via which the payment of the purchase price is to be undertaken or settled. A payment server may also be a distributed server system such as, for example, a cloud, a server array or such like.

A ‘product log-in procedure’ in the sense of the invention may mean a procedure in which the purchaser of the time-dependent article can log himself/herself in at a corresponding server such as a product-supplier server or such like and/or a product corresponding to the time-dependent article, in order to be able to utilize the time-dependent article in accordance with its intended purpose over the agreed time. The product log-in procedure may be undertaken explicitly by the user. However, the product log-in procedure may also be capable of being undertaken automatically or semi-automatically by the mobile communication device.

By virtue of the teaching according to the invention, the advantage is obtained that a point-of-sale-independent (POS-independent) mobile payment for acquirable products is made possible. Furthermore, the payment transaction is simplified further for the customer—that is to say, the purchaser of the product. In addition, a mobile POS-independent payment for time-dependent articles or time-dependent products also becomes possible.

The subject-matter of a coordinated claim relates to a mobile communication device that has been set up to execute a mobile payment-transaction method according to any method according to the invention.

By virtue of the teaching according to the invention, the advantage is obtained that a mobile communication device can be utilized for mobile payment, without a point-of-sale device having to be utilized. As a result, the payment transaction is simplified further for the customer—that is to say, the purchaser of the product. In addition, a mobile POS-independent payment for time-dependent articles or time-dependent products by means of a mobile communication device is made possible.

Before configurations of the invention are described more thoroughly in the following, it should firstly be noted that the invention is not restricted to the described components or the described method steps. Moreover, the terminology that is used also does not constitute a restriction but has merely exemplary character. To the extent that the singular is used in the description and in the claims, the plural is encompassed in each instance, unless the context explicitly excludes this.

Further exemplary configurations of the first method according to the invention will be elucidated in the following.

In accordance with a first exemplary configuration, the method further includes, in the case where the product is an article for purchase, deciding whether the article for purchase is a product of a single-use article or a product of some other article for purchase.

A ‘single-use article’ in the sense of the invention means an article for purchase that can be used in accordance with its intended purpose only once and/or that can be paid for only once. This may be, in particular, a voucher-associated bill such as arises, for example, when refueling at a gas station, in a restaurant, or for further individual events and/or articles for purchase occurring identically, as a rule, only once. Consequently, a single-use article may be regarded as an individual unique item. Accordingly, a statement concerning whether the product is a single-use article may have been stored in the item of product information which may be requested by means of the product ID.

On the other hand, ‘some other article for purchase’ in the sense of the invention means an article that does not constitute a single-use article. Consequently, some other article for purchase may be regarded as a frequently produced product that is standardized and consequently not individual.

This configuration has the advantage that single-use articles can also be paid for in the same way in mobile manner using the same method, and consequently also using the same mobile communication device.

In accordance with a further exemplary configuration, the method further includes the feature that the deciding of whether the article for purchase is a product of a single-use article or a product of some other article for purchase occurs prior to or in the course of the initiating of the mobile payment transaction by the user.

This configuration has the advantage that by this means it can be ensured, already prior to the payment, that any differences in the payment method can be detected. Furthermore, since, for example, the exclusion of a right of return may have been agreed for individual services, it may, for example, be sensible to draw the attention of the customer explicitly to the fact of the imminent acquisition of a single-use article separately on his/her mobile communication device. This is made possible by means of this configuration.

In accordance with a further exemplary configuration, the method further includes, in the case where the product is a single-use article, checking, prior to or in the course of the initiating of the mobile payment transaction by the user, whether the product has already been paid for by the user; and, in the case where the check shows that the product has already been paid for by the user, appropriate declining or terminating of the mobile payment transaction for the corresponding product.

This configuration has the advantage that it can become possible to prevent an inadvertent renewed payment for the single-use article, since such an article can be acquired only once.

In accordance with a further exemplary configuration, the method further includes, in the case where the product is a time-dependent article and where the user has already been logged in for the corresponding product, initiating a log-out procedure, said log-out procedure occurring at the request of the customer and/or by reason of a log-out event; and initiating the mobile payment transaction for the corresponding product.

A ‘log-out event’ in the sense of the invention may be an event that leads to an intended log-out of the user for the corresponding product. For example, this may be the attaining of a period of time or of a cost limit and such like.

This configuration has the advantage that it can become possible to prevent an inadvertent renewed payment for the time-dependent article.

In accordance with a further exemplary configuration, the method further includes, in the case where the product is a time-dependent article, checking, during the product log-in procedure for the user of the mobile communication device, whether the user has already been logged in for the corresponding product; and, in the case where the check shows that the user has already been logged in for the corresponding product, terminating the product log-in procedure; and confirming, by the product-supplier server to the mobile communication device, that the user has already been logged in for the corresponding product.

A ‘logging-in’ in the sense of the invention may be a procedure that may be necessary for legitimizing the user in order that said user can utilize the time-dependent product or the time-dependent article during the agreed useful life. For the exemplary case of a car-sharing provider, this logging-in may be capable of being undertaken at a car-sharing-provider server and/or in the corresponding motor vehicle, to be utilized, of the car-sharing provider.

This configuration has the advantage that in the case where no useful life for the time-based product has been agreed, a seconds-accurate or minutes-accurate billing for the time-based product being utilized can be made possible.

In accordance with a further exemplary configuration, the method further includes the feature that the product ID is readable for a mobile scanner, preferentially as a one-dimensional code and/or two-dimensional code, in the vicinity of, on or at the corresponding product and/or as a radio-frequency identification tag and/or as a near-field communication tag in the vicinity of, on, at or in the corresponding product.

A ‘one-dimensional code’ in the sense of the invention means a code that provides at least one item of information, coded in one dimensional direction. Such a code may be both provided physically on a medium, for example on a paper or board, and provided electronically on a medium, for example on a liquid-crystal display (LCD). An example of such a code may be a bar code.

A ‘two-dimensional code’ in the sense of the invention means a code that provides at least one item of information, coded in two dimensional directions. Such a code can be both provided physically on a medium, for example on a paper or board, and provided electronically on a medium, for example on a liquid-crystal display (LCD). An example of such a code may be a QR code.

This configuration has the advantage that standards current today become capable of being utilized for the purpose of providing coded information for products to be purchased, by virtue of which the product ID can be provided inexpensively.

A ‘mobile scanner’ in the sense of the invention means a scanner that can be held in one hand and is suitable to read out a product ID. Preferentially, such a mobile scanner can read or receive codes optically and/or by radio technology. Preferably, camera optics of a mobile communication device according to the invention can act as an optical mobile scanner, in which case a CPU of this mobile communication device can evaluate the scan of the camera optics. A radio-technology mobile scanner may, however, also be, for example, a radio antenna with appropriate logic. Such a radio-technology mobile scanner solution may be a radio-technology device in a mobile communication device.

A mobile communication device according to the invention may provide at least one of the two mobile types of scan; preferentially, such a mobile communication device provides both an optical and a radio-technology mobile type of scan.

This configuration has the advantage that a simple way to scan a product ID in mobile manner and to pay for the corresponding product subsequently in mobile manner are provided. Furthermore, both procedures—that is to say, the mobile scanning and the mobile payment—can preferentially be made possible with the same mobile communication device, by virtue of which the mobile payment can be simplified still further.

In accordance with a further exemplary configuration, the method further includes the feature that the corresponding item of price information for the corresponding product is not contained in the unique product ID of the corresponding product.

This configuration has the advantage that use may be made of product IDs that are held very simply. The further product information associated with the product ID may in this case have been isolated—that is to say, it may be provided on a product-supplier server. This may have the advantage that such a solution can be offered very flexibly and inexpensively.

In accordance with a further exemplary configuration, the method further includes sending of the item of payment-price information for the product to be paid for to the mobile communication device, by at least one server involved in the mobile payment transaction.

This configuration has the advantage that the user of the mobile communication device has transparency with respect to the purchase price to be paid.

The invention consequently permits a mobile payment to be made possible, wherein the customer merely needs his/her mobile communication appliance—that is to say, he/she is not dependent on payment cash-desks, payment terminals, point-of-interest devices and such like. This also applies to voucher-associated products such as—for example, but not to be understood as being conclusive—a paper bill such as is found in a restaurant, for example, a bill received by email, and a gas-station bill.

The invention will be elucidated more thoroughly in the following with reference to the figures. Shown in the latter are:

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 a schematic flow chart of a proposed method according to an exemplary configuration of the invention; and

FIG. 2 a schematic flow chart of a proposed method according to a further exemplary configuration of the invention.

### DETAILED DESCRIPTION OF THE DRAWINGS

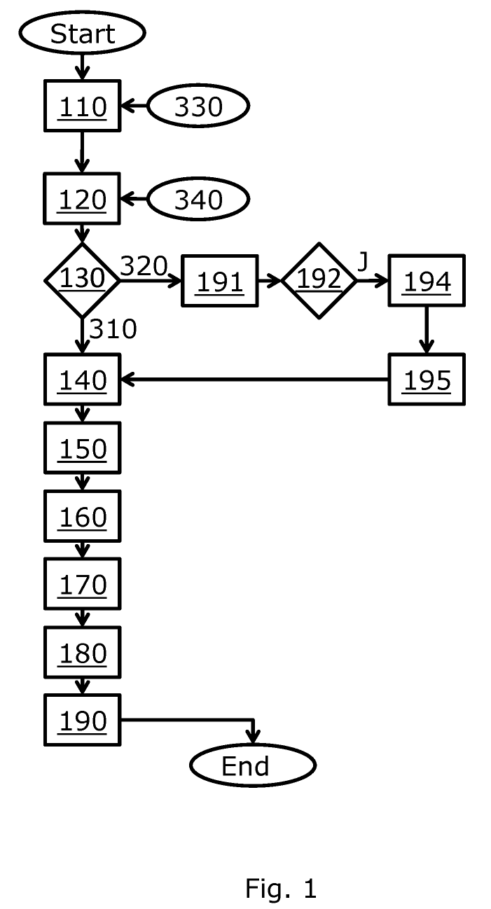

FIG. 1 shows a schematic flow chart of a proposed method according to an exemplary configuration of the invention.

FIG. 1 shows a flow chart of a method 100 for a mobile payment transaction 210 (not represented in FIG. 1) using a mobile communication device 200 (not represented in FIG. 1), said method comprising: reading-in 110 of a unique product ID 330 by a user of the mobile communication device 200 using the mobile communication device 200; retrieving 120 an item of product information 340 relating to the unique product ID 330 from a product-supplier server 400 (not represented in FIG. 1); deciding 130 whether the product ID 330 concerns a product 300 (not represented in FIG. 1) of an article for purchase 310 or a product 300 of a time-dependent article 320; initiating 140 of a mobile payment transaction 210 by the user of the mobile communication device 200 on the basis of the unique product ID 330; sending 150 an item of payment information 220 from the mobile communication device 200 to a payment server 500 (not represented in FIG. 1) on the basis of the unique product ID 330; establishing 160 a communications link from the payment server 500 to the product-supplier server 400 on the basis of the item of payment information 220; receiving 170 of an item of payment-price information 350 (not represented in FIG. 1) by the payment server 500; acknowledging 180 a payment price 240 (not represented in FIG. 1) to the product-supplier server 400 on the basis of the item of payment-price information 350; and confirming 190 of a completion of the mobile payment transaction 210 to the mobile communication device 200 by at least one server 400, 500 involved in the mobile payment transaction 210. And, in the case where the product 300 is a time-dependent article 320, initiating 191 a product log-in procedure 230 (not represented in FIG. 1) for the user of the mobile communication device 200 on the basis of the unique product ID 330; sending 192 a log-in request 231 from the mobile communication device 200 to the product-supplier server 400 on the basis of the unique product ID 330; logging-in 194 of the user of the mobile communication device 200 for the time-dependent article 320 at the product-supplier server 400; and confirming 195, by the product-supplier server 400 to the mobile communication device 200, of a logging-in 194 of the user for the corresponding product 300. In the course of the sending 192 of the log-in request 231 it can consequently be queried whether a logging-in for the time-dependent article 320 is to be undertaken or not. In FIG. 1, for the sake of clarity the sending 192 of the log-in request 231 has been represented in simplified manner as a decision block 192, in order not to overload FIG. 1 which has been represented.

After initiating 140 of the mobile payment transaction 210 by the user of the mobile communication device 200, the mobile payment transaction 210 can be terminated by the user in the case where the latter has, for example, changed his/her mind and would not like to acquire the product 300 after all, or the user would like to pay for the product 300 only at a later time, for example.

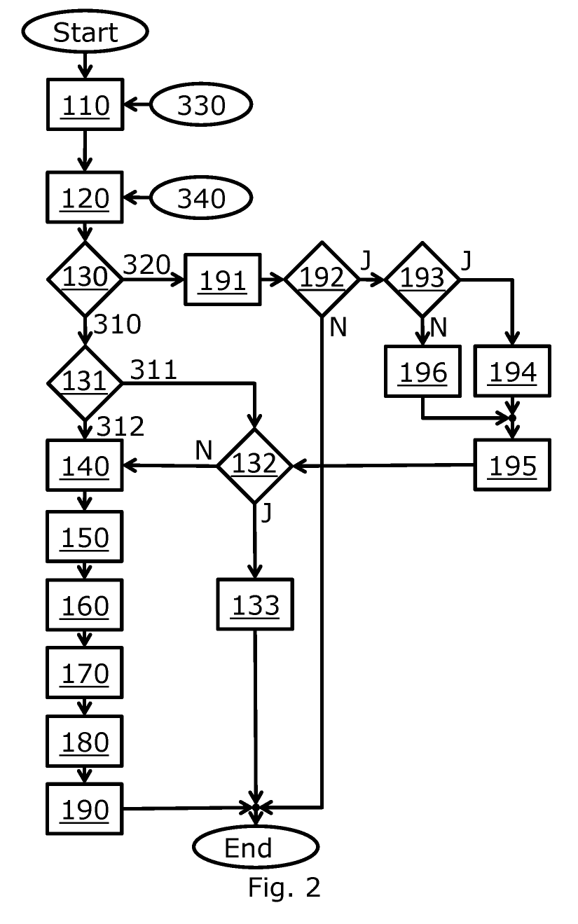

FIG. 2 shows a schematic flow chart of a proposed method according to a further exemplary configuration of the invention.

FIG. 2 shows a flow chart of a method that has been extended in comparison with the method from FIG. 1. What was said previously with respect to FIG. 1 continues to apply correspondingly to FIG. 2.

As can be gathered from FIG. 2, in addition the method includes, in the case where the product 300 is an article for purchase 310, deciding 131 whether the article for purchase 310 is a product 300 of a single-use article 311 or a product 300 of some other article for purchase 312.

In FIG. 2 the deciding 131 of whether the article for purchase 310 is a product 300 of a single-use article 311 or a product 300 of some other article for purchase 312 occurs prior to or in the course of the initiating 140 of the mobile payment transaction 210 by the user.

In addition, the method in FIG. 2 includes, in the case where the product 300 is a single-use article 311, checking 132, prior to or in the course of the initiating 140 of the mobile payment transaction 210 by the user, whether the product 300 has already been paid for by the user. And, in the case where the check 132 shows that the product 300 has already been paid for by the user, corresponding declining or terminating 133 of the mobile payment transaction 210 for the corresponding product 300.

In the case where the product 200 is a time-dependent article 320, the method of FIG. 2 further includes, in the case where the user has already been logged in 194 for the corresponding product 300, initiating a log-out procedure, said log-out procedure occurring at the request of the customer and/or by reason of a log-out event, and initiating 140 the mobile payment transaction 210 for the corresponding product 300.

Furthermore, the method of FIG. 2 includes, in the case where the product 300 is a time-dependent article 320, checking 193, during the product log-in procedure 230 for the user of the mobile communication device 200, whether the user has already been logged in 194 for the corresponding product 300. And, in the case where the check 193 shows that the user has already been logged in 194 for the corresponding product 200, terminating 196 the product log-in procedure 230 for the user, and confirming 195, by the product-supplier server 400 to the mobile communication device 200, that the user has already been logged in 194 for the corresponding product 300.

The idea of the invention can be summarized as follows. A method and a relevant device are provided, by virtue of which it can become possible that a customer can pay for an arbitrary product by means of his/her mobile communication device according to the invention, without being dependent for this on a separate payment cash-desk or a POI. After a scanning of a product ID of the product to be acquired, the mobile payment transaction can take place merely between the mobile communication device according to the invention, a product server of the product supplier, and a payment server. The payment server and the product server may also have been configured jointly as one server or as a server structure. This can simplify the payment transaction for the customer and keep the costs of the payment transaction down for the enterprise offering the product.

### LIST OF REFERENCE SYMBOLS

100 method
110 reading in a 330
120 retrieving a 340
130 deciding whether 330 is that of a 310 or that of a 320
131 deciding whether 310 is a 311 or a 312
132 checking whether 300 has already been paid for by the user
133 declining or terminating or not initiating the 210 for the 300
140 initiating a 210
150 sending a 220
160 establishing a communications link
170 receiving of a 350 by the 500
180 acknowledging a 240 to the 400
190 confirming a completion of the 210 to the 200
191 initiating a 230
192 sending a 231
193 checking whether the user is already 194 for the 300
194 logging-in of the user of the 200 for the 320 at the 400
195 confirming a 194 of the user for the 300
196 terminating the 230
200 mobile communication device
210 mobile payment transaction
220 item of payment information
230 product log-in procedure
231 log-in request
250 mobile scanner
300 product
310 article for purchase
311 single-use article
312 other article for purchase
320 time-dependent article
330 unique product ID
340 item of product information
350 item of payment-price information
400 product-supplier server
500 payment server

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for a mobile payment transaction using a mobile communication device, said method comprising the acts of:
reading-in of a unique product ID using the mobile communication device, by a user of the mobile communication device,
retrieving an item of product information relating to the unique product ID from a product-supplier server,
deciding whether the product ID concerns a product of an article for purchase or a product of a time-dependent article,
initiating of a mobile payment transaction by the user of the mobile communication device on the basis of the unique product ID,
sending an item of payment information from the mobile communication device to a payment server on the basis of the unique product ID,
establishing a communications link from the payment server to the product-supplier server on the basis of the item of payment information,
receiving of an item of payment-price information by the payment server,
acknowledging a payment price to the product-supplier server on the basis of the item of payment-price information, and
confirming of a completion of the mobile payment transaction to the mobile communication device by at least one server involved in the mobile payment transaction,
wherein the method further comprises, when the product is a time-dependent article, the acts of:
initiating a product log-in procedure for the user of the mobile communication device on the basis of the unique product ID,
sending a log-in request from the mobile communication device to the product-supplier server on the basis of the unique product ID,
logging-in the user of the mobile communication device for the time-dependent article at the product-supplier server, and
confirming, by the product-supplier server to the mobile communication device, of a logging-in of the user for a corresponding product.

2. The method as claimed in claim 1, wherein the method further comprises, when the product is an article for purchase, the act of:
deciding whether the article for purchase is a product of a single-use article or a product of some other article for purchase.

3. The method as claimed in claim 2, wherein
said deciding whether the article for purchase is the product of the single-use article or the product of some other article for purchase occurs prior to or in the course of the initiating of the mobile payment transaction by the user.

4. The method as claimed in claim 2, wherein the method further comprises, when the product is a single-use article, the acts of:
prior to or in the course of the initiating of the mobile payment transaction by the user;
checking whether the product has already been paid for by the user; and
declining or terminating of the mobile payment transaction for the product when said checking indicates the product has already been paid for by the user.

5. The method as claimed in claim 3, wherein the method further comprises, when the product is a single-use article, the acts of:
prior to or in the course of the initiating of the mobile payment transaction by the user;
checking whether the product has already been paid for by the user; and
declining or terminating of the mobile payment transaction for the product when said checking indicates the product has already been paid for by the user.

6. The method as claimed in claim 1, wherein the method further comprises, when the product is a time-dependent article and the user has already been logged in for the corresponding product, the acts of:
initiating a log-out procedure, said log-out procedure occurring at the request of the customer and/or by reason of a log-out event; and
initiating the mobile payment transaction for the corresponding product.

7. The method as claimed in claim 2, wherein the method further comprises, when the product is a time-dependent article and the user has already been logged in for the corresponding product, the acts of:
initiating a log-out procedure, said log-out procedure occurring at the request of the customer and/or by reason of a log-out event; and
initiating the mobile payment transaction for the corresponding product.

8. The method as claimed in claim 3, wherein the method further comprises, when the product is a time-dependent article and the user has already been logged in for the corresponding product, the acts of:
initiating a log-out procedure, said log-out procedure occurring at the request of the customer and/or by reason of a log-out event; and
initiating the mobile payment transaction for the corresponding product.

9. The method as claimed in claim 5, wherein the method further comprises, when the product is a time-dependent article and the user has already been logged in for the corresponding product, the acts of:
initiating a log-out procedure, said log-out procedure occurring at the request of the customer and/or by reason of a log-out event; and
initiating the mobile payment transaction for the corresponding product.

10. The method as claimed in claim 1, wherein the method further comprises, when the product is a time-dependent article, the act of:
checking, during the product log-in procedure for the user of the mobile communication device, whether the user has already been logged in for the corresponding product, and
wherein the method further comprises, when said checking indicates that the user has already been logged in for the corresponding product, the acts of:
terminating the product log-in procedure for the user; and
confirming, by the product-supplier server to the mobile communication device, that the user has already been logged in for the corresponding product.

11. The method as claimed in claim 2, wherein the method further comprises, when the product is a time-dependent article, the act of:
checking, during the product log-in procedure for the user of the mobile communication device, whether the user has already been logged in for the corresponding product, and
wherein the method further comprises, when said checking indicates that the user has already been logged in for the corresponding product, the acts of:
terminating the product log-in procedure for the user; and
confirming, by the product-supplier server to the mobile communication device, that the user has already been logged in for the corresponding product.

12. The method as claimed in claim 3, wherein the method further comprises, when the product is a time-dependent article, the act of:
checking, during the product log-in procedure for the user of the mobile communication device, whether the user has already been logged in for the corresponding product, and
wherein the method further comprises, when said checking indicates that the user has already been logged in for the corresponding product, the acts of:
terminating the product log-in procedure for the user; and
confirming, by the product-supplier server to the mobile communication device, that the user has already been logged in for the corresponding product.

13. The method as claimed in claim 4, wherein the method further comprises, when the product is a time-dependent article, the act of:
checking, during the product log-in procedure for the user of the mobile communication device, whether the user has already been logged in for the corresponding product, and
wherein the method further comprises, when said checking indicates that the user has already been logged in for the corresponding product, the acts of:
terminating the product log-in procedure for the user; and
confirming, by the product-supplier server to the mobile communication device, that the user has already been logged in for the corresponding product.

14. The method as claimed in claim 6, wherein the method further comprises, when the product is a time-dependent article, the act of:
checking, during the product log-in procedure for the user of the mobile communication device, whether the user has already been logged in for the corresponding product, and
wherein the method further comprises, when said checking indicates that the user has already been logged in for the corresponding product, the acts of:
terminating the product log-in procedure for the user; and
confirming, by the product-supplier server to the mobile communication device, that the user has already been logged in for the corresponding product.

15. The method as claimed in claim 1, wherein the product ID is configured to be at least one of (i) read out for a mobile scanner as one of a one-dimensional code and a two-dimensional code, in a vicinity of, on or at the corresponding product, (ii) as a radio-frequency identification tag, and (iii) as a near-field communication tag in the vicinity of, on, at or in the corresponding product.

16. The method as claimed in claim 1, wherein the corresponding item of payment-price information for the corresponding product is not contained in the unique product ID of the corresponding product.

17. The method as claimed in claim 16, wherein the method further comprises sending the item of payment-price information for the product to be paid for to the mobile communication device by at least one server involved in the mobile payment transaction.

18. A mobile communication device configured to execute a mobile payment-transaction by:
reading-in of a unique product ID using the mobile communication device, by a user of the mobile communication device,
retrieving an item of product information relating to the unique product ID from a product-supplier server,
determining whether the product ID concerns a product of an article for purchase or a product of a time-dependent article,
initiating of a mobile payment transaction by the user of the mobile communication device on the basis of the unique product ID,
sending an item of payment information from the mobile communication device to a payment server on the basis of the unique product ID,
establishing a communications link from the payment server to the product-supplier server on the basis of the item of payment information,
receiving of an item of payment-price information by the payment server,
acknowledging a payment price to the product-supplier server on the basis of the item of payment-price information, and
confirming of a completion of the mobile payment transaction to the mobile communication device by at least one server involved in the mobile payment transaction,
wherein, when the product is a time-dependent article, the mobile communication device is further configured to execute the mobile payment-transaction by:
initiating a product log-in procedure for the user of the mobile communication device on the basis of the unique product ID,
sending a log-in request from the mobile communication device to the product-supplier server on the basis of the unique product ID,
logging-in the user of the mobile communication device for the time-dependent article at the product-supplier server, and
confirming, by the product-supplier server to the mobile communication device, of a logging-in of the user for a corresponding product.
